(19) United States
(12) Patent Application Publication
(10) Pub. No.: US 2026/0061869 A1
(43) Pub. Date: Mar. 5, 2026

(54) INDUCTIVE CHARGING DEVICE FOR A VEHCILE CHARGING SYSTEM

(71) Applicant: MAHLE International GmbH, Stuttgart (DE)

(72) Inventor: Mike Boettigheimer, Kornwestheim (DE)

(21) Appl. No.: 19/104,200

(22) PCT Filed: Jun. 6, 2023
(86) PCT No.: PCT/EP2023/065152

§ 371 Date: Feb. 14, 2025

(30) Foreign Application Priority Data
Aug. 16, 2022 (DE) 10 2022 120 696.3
Sep. 28, 2022 (DE) 10 2022 125 039.3

(51) Int. Cl. B60L 53/36; B60L 53/38

(52) U.S. Cl. CPC B60L 53/36; B60L 53/38

(57) ABSTRACT

An inductive charging device for a vehicle charging system may include an energy transmission winding, at least one flux guiding element, a short-proximity positioning transmitter unit configured to provide at least one short-proximity positioning signal, and a long-proximity positioning transmitter unit configured to provide at least one long-proximity positioning signal.

### CROSS-REFERENCE TO RELATED APPLICATION

This application claims priority to International Patent Application No. PCT/EP2023/065152, filed on Jun. 6, 2023, German Patent Application No. DE 10 2022 120 696.3, filed on Aug. 16, 2022, and German Patent Application No. DE 10 2022 125 039.3, filed on Sep. 28, 2022, the contents of all of which are hereby incorporated by reference in their entirety.

### TECHNICAL FIELD

The invention relates to an inductive charging device for a vehicle charging system of the type described in the independent claim, as well as to a vehicle charging system.

### BACKGROUND

DE 10 2014 202 747 A1 discloses a double winding system which is used to determine a positional deviation between a primary coil and a secondary coil of an inductive charging system. The two windings of the double winding system are offset with respect to each other by a certain angle and wound around a common ferrite element. The magnetic field of the primary coil induces a voltage in the two windings. The two voltages are evaluated by an evaluation unit and a position deviation between the primary coil and the secondary coil is calculated. The double winding system shown is used as a sensor for only one method that detects a position deviation. Such a method can become imprecise or no longer function adequately with a minimum bar level.

### SUMMARY

The present invention is concerned with the task of providing improved or at least alternative embodiments for an inductive charging device of the type mentioned at the beginning, in particular those which enable a positioning method over as wide a range of distances as possible.

The ability to charge vehicles inductively offers a plurality of advantages over conventional conductive charging. First and foremost, there is the added convenience of not having to fiddle with sometimes very heavy charging cables and plugs. However, it is important for the inductive charging process that the vehicle's inductive charging device is positioned as closely as possible to the stationary inductive charging device, for example on the ground. This is difficult due to the purely manual positioning of the vehicle over the stationary inductive charging device and the driver requires support from an assistance system, which either provides it with information about a positional deviation between the mobile inductive charging device in the vehicle and the stationary inductive charging device or from an automated positioning system, which takes over the parking process automatically. A sensor system is required that can detect a corresponding deviation in position. It is advantageous if no initial calibration is required between the stationary inductive charging device and the mobile inductive charging device in the vehicle. The longest possible range is also advantageous for the positioning system. This means that the positioning system should be able to precisely determine a positional deviation at the greatest possible distance between a stationary inductive charging device and a mobile inductive charging device in the vehicle and also function up to a sufficiently precise positioning.

An inductive charging device for a vehicle charging system is proposed, with an energy transmission winding and at least one flux guiding element and with a short-proximity positioning transmitter unit that is capable of generating at least one short-proximity positioning signal and a long-proximity positioning transmitter unit that is capable of generating at least one long-proximity positioning signal.

With inductive charging, energy is transmitted in the form of a magnetic field between two inductive charging devices, usually between a stationary charging device and a mobile inductive charging device.

The term “inductive charging device” thus refers here only to one of at least two parts that are necessary for an induction charging process for energy transmission. During the induction charging process, an energy transmission winding in an inductive charging device generates an alternating magnetic field. This alternating magnetic field induces a voltage in a further energy transmission winding of a further inductive charging device. This additional inductive charging device thus serves as a counterpart for this specific charging process. The energy is transmitted wirelessly and absorbed by inducing a voltage.

Inductive charging devices can be used for inductive charging of vehicles. In principle, an inductive charging device according to the invention can be used for any type of land, water, or air vehicle that has an electric or hybrid drive. Passenger cars, buses, and trucks are particularly mentioned.

A vehicle charging system comprises at least one mobile inductive charging device and a further, usually stationary inductive charging device. A mobile inductive charging device can, for example, be mounted on and/or in a vehicle.

An inductive charging device on and/or in the vehicle is therefore suitable for absorbing the magnetic field and providing electrical energy to a vehicle's energy storage device, for example a battery or an accumulator in the vehicle.

In principle, a vehicle charging system can also be used for bidirectional charging. In this case, the vehicle can also temporarily feed energy from the energy storage device into the power grid via the vehicle charging system.

Further important features and advantages of the invention are apparent from the dependent claims, from the drawings, and from the associated description of the figures with reference to the drawings.

An inductive charging device has an energy transmission winding that can efficiently receive a magnetic field from another energy transmission winding during the charging process and/or can emit a magnetic field. Preferably, power from 3 kW to 500 kW can be transmitted, particularly preferably from 3 kW to 50 kW.

Generally speaking, a coil is defined here as a component for generating or receiving a magnetic field. A coil can consist of a winding and optionally further elements such as a magnetic core and a coil former. A winding is a coiled arrangement of a conductor. A winding can consist of one or more turns, wherein a turn refers to a full revolution of a conductor. Generally speaking, a winding can also consist of less than one turn, for example 0.5 turns. Of course, a non-complete number of turns, such as 2.5 turns, is also possible.

An energy transmission winding can be designed in various forms and can, for example, consist of a high frequency stranded wire with a diameter of between 0.5 mm and 10 mm, preferably made of copper.

A flux guiding element is suitable for guiding a magnetic field in a predetermined manner. It has a high magnetic permeability of μᵣ>1, preferably μᵣ>50, particularly preferably μᵣ>100. The flux guiding element is a magnetic core for the energy transmission winding. In particular, the magnetic field is influenced by the high permeability in such a way that the greatest possible magnetic flux is transferred to the energy transmission winding. With a flux guiding element, the energy transmission winding picks up a greater magnetic flux than without a flux guiding element, all other parameters being equal. A flux guiding element can be made of a ferromagnetic or preferably of a ferrimagnetic material, particularly preferably of a ferrite. A flux guiding element can preferably be plate-like-in the form of a planar core-and be arranged in the inductive charging device on the side of the energy transmission winding that faces away from the opposite side, i.e., the other inductive charging device.

A positioning transmitter unit is a device that enables at least one positioning signal to be transmitted. A positioning transmitter unit can consist of several elements, which can also be spatially separated from each other. It is also possible for a positioning transmitter unit to emit several positioning signals. A positioning transmitter unit is used to generate the positioning signals for a positioning method.

For an optimal positioning process, it is important that the longest possible range is achieved, i.e., that positioning is possible at the greatest possible distance between the two inductive charging devices. On the other hand, it is important that positioning is still possible even at small distances between the two inductive charging devices until sufficiently precise positioning is achieved.

The distances here always refer to a distance to an optimum positioning. In the case of stationary inductive charging devices arranged on or in the substrate, optimum positioning may be present if the two centers of the inductive charging devices are vertically above each other in the plane parallel to the substrate. In this case, the distances are always determined in relation to these centers. The distance between the two inductive charging devices therefore refers here to the distance between the two centers of the two inductive charging devices in relation to the plane parallel to the substrate. Different positioning methods may be optimal for different regions of distances between the two inductive charging devices. For example, a positioning method that achieves the greatest possible range, i.e., the greatest possible distance between the two inductive charging devices, may be inadequate for small distances. A positioning method that delivers precise values at short distances may have too short a range. It is therefore advantageous to combine two positioning methods that provide sufficient or optimum values for different regions of distances between the two inductive charging devices. It may also be advantageous to use different positioning transmitter units for the two positioning methods.

The terms “short-proximity positioning” and “long-proximity positioning” refer to two different distance ranges between the two inductive charging devices or their two centers. The distance ranges can overlap. The terms “short-proximity positioning” and “long-proximity positioning” do not explicitly refer to a short-proximity or long-proximity field property of electromagnetic waves.

A short-proximity positioning transmitter unit is a positioning transmitter unit that can emit positioning signals that are sufficient or optimal for positioning at relatively close distances between the two inductive charging devices. A short-proximity positioning transmitter unit is suitable for emitting a short-proximity positioning signal during a positioning process. In particular, a short-proximity positioning transmitter unit can emit short-proximity positioning signals that are suitable for positioning up to a sufficiently accurate positioning.

A short-proximity positioning can cover a region up to a maximum distance of the short-proximity positioning. The maximum distance refers to the distance between the two inductive charging devices. The maximum distance refers to the distance for optimum positioning. In the case of a stationary inductive charging device arranged on or in the substrate, the optimum positioning is that the two centers of the inductive charging devices are one above the other. The maximum distance therefore refers to the distance between the two centers in the plane of travel of the two inductive charging devices.

The maximum distance of the short-proximity positioning can be less than two meters. Preferably, the maximum distance can be one meter. The short-proximity positioning thus preferably covers a region of a few centimeters to one meter distance between the centers of the two inductive charging devices.

A long-proximity positioning transmitter unit is a positioning transmitter unit that can emit one or more positioning signals that are sufficient or optimal for positioning at relatively large distances between the two inductive charging devices. A long-proximity positioning transmitter unit is suitable for transmitting a long-proximity positioning signal during a positioning process. In particular, a long-proximity positioning transmitter unit can emit long-proximity positioning signals that are sufficiently accurate for positioning up to a maximum range. The maximum range here is the maximum distance between the two inductive charging devices that can be achieved by combining a short-proximity and a long-proximity positioning method.

Long-proximity positioning can cover a region between a minimum and a maximum distance for long-proximity positioning. The maximum distance for long-proximity positioning should be at least as great as the distance from which a driver can no longer see the stationary inductive charging device through the windshield when driving towards it. The maximum distance for long-proximity positioning can be several meters. Preferably, the maximum distance for long-proximity positioning can be between 5 and 15 m, particularly preferably 10 m. The long-proximity positioning can have a minimum distance below which positioning with this method is no longer possible. Advantageously, the minimum distance for long-proximity positioning is at least as great as the maximum distance for short-proximity positioning. However, it is also possible that the minimum distance for long-proximity positioning is smaller than the maximum distance for short-proximity positioning. In this case, there is a short transition range in which positioning is required without a positioning method. For example, positioning can simply continue in the corresponding direction after the last evaluated signal of the long-proximity positioning until the short-proximity positioning provides evaluable signals. Alternatively, it is also possible for the minimum distance for long-proximity positioning to be greater than the maximum distance for short-proximity positioning. In this case, the two positioning methods overlap.

The minimum distance for long-proximity positioning can be between 20 cm and 1 m. Preferably, the minimum distance for long-proximity positioning can be approx. 0.5 m.

The term “long-proximity” therefore preferably refers to a distance range between 0.5 m and 10 m. The term “short-proximity” therefore preferably refers to a distance range of less than 1 m.

It is understood that the above-mentioned features and those yet to be explained below can be used not only in the combination indicated in each case, but also in other combinations or on their own, without deviating from the scope of the present invention.

Preferably, the inductive charging device is a mobile inductive charging device which is arranged on and/or in a vehicle, or the inductive charging device is a stationary inductive charging device.

A stationary inductive charging device is the non-mobile part of a vehicle charging system, i.e., the part that does not move with the vehicle.

A stationary inductive charging device can preferably be located on, at or in a floor. This can be an inductive charging device mounted on the substrate or an inductive charging device recessed into a substrate or ground. A floor can be a road, a parking lot surface, a garage floor, a floor in a parking garage or another building. Alternatively, a stationary inductive charging device can also be located on walls or similar.

It is also possible that it is a stationary inductive charging device for a dynamic inductive charging process. In a dynamic inductive charging process, a vehicle's energy storage device can be charged while the vehicle is moving. In this case, for example, the stationary inductive charging device can extend along the road under, in or on the road surface.

A mobile inductive charging device can be arranged on and/or in a vehicle. Generally speaking, this refers to the part of a vehicle charging system that moves with the vehicle.

The short-proximity positioning transmitter unit has the advantage of having several short-proximity transmitter windings, preferably at least four short-proximity transmitter windings, which are arranged at a distance from one another.

A short-proximity transmission winding is one or part of a transmit coil that can generate a short-proximity positioning signal. The short-proximity positioning signal can be an alternating magnetic field and have a specific frequency or a specific frequency band. The frequencies of the short-proximity positioning signals can be in the region of 5 kHz to 150 kHz, preferably in the region of 110 kHz to 148.5 kHz, particularly preferably in the region of 120 kHz and 145 kHz. The frequencies used can be, for example, several of the following frequencies: 111.483 kHz and 111.982 kHz and 112.994 kHz and 113.507 kHz and 116.009 kHz. A transmit coil can be significantly smaller than an energy transmission winding and can also be smaller than a sensor winding. A short-proximity transmission winding can, for example, be designed in the form of a flat coil. The short-proximity transmission winding can be arranged at a distance from the energy transmission winding and at a distance from the flux guiding elements. Alternatively, a short-proximity transmission winding can also be arranged in the region of the energy transmission winding and/or in the region of the flux guiding elements. In principle, a short-proximity transmission winding can be arranged at any level of an inductive charging device. In the case of inductive charging devices arranged parallel to the driving plane, this corresponds to an arrangement at different heights. A short-proximity transmission winding can be arranged between the at least one flux guiding element and the energy transmission winding. Alternatively, a short-proximity transmission winding can lie in the same plane as the energy transmission winding. In a further alternative embodiment, a short-proximity transmission winding may be closer to the further inductive charging device, which forms the counterpart during an inductive charging process, than the energy transmission winding and than the flux guiding elements. In other words, a short-proximity transmission winding can be arranged on the side of the energy transmission winding facing away from the flux guiding elements. It is also possible that the short-proximity transmission windings are arranged at a distance from the inductive charging device and are only functionally assigned to it. By using several short-proximity transmission windings, a simpler positioning method is possible.

If the received signals can be assigned to the individual positioning signals of the short-proximity transmission windings, the relative or absolute distance to the respective short-proximity transmission windings can be determined from this and used for positioning. For example, the relative distances to two neighboring short-proximity transmission windings can be compared with each other.

The use of at least four short-proximity transmission windings is advantageous. For example, they can be arranged in the form of a rectangle around a target area. By simply comparing the intensities of the respective different positioning signals, it is possible to position both in the longitudinal direction of the vehicle and perpendicular to the longitudinal direction of the vehicle. A further advantage is that this provides redundancy, as two ratios are formed in each spatial direction. This is particularly relevant for the proposed system, as parasitic effects can occur at very short distances between the short-proximity transmission winding and the sensor winding, so that the spatially distributed signals no longer show their maximum directly at the position of the short-proximity transmission winding, but that a pronounced “dip” is present there. The term “dip” is used here to describe a local minimum between two local maxima. The position-dependent signal therefore has a characteristic curve with a “double hump”. Such a curve leads to a falsification of the detected position. As the effect of the pronounced “dip” in the spatial distribution only occurs at very short distances, the redundancy proposed here is advantageous, as the signals from the short-proximity transmission windings can always be evaluated at a greater distance.

Particularly advantageous are the short-proximity transmission windings with a winding axis perpendicular to the substrate.

A short-proximity transmission winding can be designed as a flat coil. A flat coil can be a spiral flat coil, in particular a circular spiral flat coil or a rectangular spiral flat coil. A spiral flat coil can be wound in the form of an Archimedean spiral. The shape of the turn can be circular (circular spiral flat coil), but other shapes are also possible, such as square-like or rectangle-like or even similar to a rectangle with rounded corners (rectangular spiral flat coil). The spiral can lie in one plane. A flat coil is particularly suitable for use in a vehicle, as the installation space along the height of a vehicle is limited. A flat coil is advantageous because it has the smallest possible expansion in this direction. An expansion in the two dimensions parallel to the substrate and perpendicular to the height of a vehicle is advantageous, as this maximizes the tolerance range for positioning in which the coupling between the energy transmission windings is still sufficient for energy transmission.

Alternatively, a short-proximity transmission winding can be designed as a cylindrical coil. A cylindrical coil can be quite flat in this case. A corresponding cylindrical coil can be wound around a winding body and have a height along the winding axis of between 5 mm and 15 mm.

A short-proximity transmission winding can be made of copper. A short-proximity transmission winding can have between 10 and 50 turns. Preferably, a short-proximity transmission winding has between 20 and 40 turns. Particularly preferably, a short-proximity transmission winding has 28 turns. A short-proximity transmission winding can have a diameter of between 50 and 100 mm. For example, a short-proximity transmission winding has a diameter of 72 mm.

The short-proximity transmission windings are preferably suited to generate a short-proximity positioning signal. A short-proximity transmission winding, as part of an electric coil, can generate an alternating magnetic field by applying an alternating electric current. This alternating magnetic field can, for example, induce an electrical voltage in another remote winding. This means that the same basic physical principle used for energy transmission, namely induction, can also be used to transmit positioning signals. This offers several advantages. First and foremost, certain components, such as electronic components and flux guiding elements, can be used for both energy transmission and positioning signal transmission. An alternating electric current with an effective value of between 500 mA and 1 A can flow through the short-proximity transmission winding. Preferably, the effective value of the alternating current is 700 mA.

The short-proximity positioning signals can be alternating magnetic fields with different frequencies or with the same frequency but different pulse widths.

In a short-proximity positioning method, different transmitted and received short-proximity positioning signals can be compared and thus a deviation from an optimal position can be determined. To do this, several short-proximity positioning signals must be generated that can be distinguished from one another. These short-proximity positioning signals must differ from each other in a differentiation criterion. One possible differentiation criterion is the frequency. The intervals between two frequencies can be between 0.1 and 1 kHz. The frequencies used can be, for example, four or more of the following frequencies: 111.483 kHz and 111.982 kHz and 112.994 kHz and 113.507 kHz and 116.009 kHz.

Another option is to select only one frequency for all short-proximity positioning signals, but to use different pulse widths for the various short-proximity positioning signals as a distinguishing criterion.

The long-proximity positioning transmitter unit has a long-proximity positioning signal winding, wherein the long-proximity positioning signal winding is designed as a solenoid with a winding axis in the longitudinal direction of the vehicle or the nominal longitudinal direction of the vehicle and the flux guiding element is suitable for guiding a magnetic field during an energy transmission process that takes place between a further inductive charging device and the energy transmission winding, to conduct a magnetic field and encloses the long-proximity positioning signal winding, at least one of the at least one flux guiding elements and the long-proximity positioning signal winding is suitable for generating the long-proximity positioning signal.

A long-proximity positioning signal winding can emit a positioning signal during a positioning process.

A long-proximity positioning signal winding can have several turns, preferably between 10 and 15 turns, particularly preferably 13 turns. For example, a long-proximity positioning signal winding can generate an alternating magnetic field with a certain frequency due to an alternating current. The effective current of the alternating current in the long-proximity positioning signal winding can be between 100 and 500 mA. The rms current of the alternating current is preferably 260 mA.

In principle, an energy transmission winding can also emit a positioning signal, but it is advantageous, as proposed here, to use a separate long-proximity positioning signal winding to generate a positioning signal. In particular, the long-proximity positioning signal winding can generate magnetic fields which are more suitable for positioning and, in particular, enable a greater range with the same power. The energy transmission windings are designed to couple as well as possible with the corresponding counterpart. They therefore generally do not have a long range with regard to the transmission or reception of magnetic fields in the longitudinal direction of the vehicle or the nominal longitudinal direction of the vehicle. However, this is crucial for a positioning process.

During positioning, the maximum possible power or the maximum possible magnetic fields of the positioning signal are severely limited. They are significantly lower than is the case with an energy transmission process. During the positioning process, there is no vehicle on the stationary inductive charging device. It is therefore possible, for example, for a person to be standing on the stationary inductive charging device. To ensure that the magnetic fields remain safe for a person, they must not exceed flux densities of 27 μT or 6.25 μT, depending on the frequency range.

With a proposed long-proximity positioning signal winding, it is possible to generate positioning signals that comply with the limit values or reference values and still enable a long range.

A solenoid is also known as a cylindrical coil or solenoid coil. A solenoid can be wound in the form of a helix or a cylindrical spiral. However, the turn shape does not have to be circular, but can also have other shapes, such as square or rectangular or even similar to a rectangle with rounded corners. The important difference to the flat coil is that the turns are not in one plane, but extend along an axis. However, two or more turns can also run parallel and thus be located in the same plane perpendicular to the axis.

A stationary inductive charging device has a nominal longitudinal direction of the vehicle. This is the direction in which the longitudinal direction of the vehicle should be after a successful positioning process.

If the long-proximity positioning signal winding is located in a mobile inductive charging device of a vehicle, the winding axis of the long-proximity positioning signal winding is aligned in the longitudinal direction of the vehicle. If the long-proximity positioning signal winding is located in a stationary inductive charging device, the winding axis of the long-proximity positioning signal winding is aligned in the nominal longitudinal direction of the vehicle.

The long-proximity positioning signal winding can have an extension along the winding axis of between 10 mm and 60 mm. Preferably, the long-proximity positioning signal winding has an extension along the winding axis of 40 mm.

In the proposed arrangement, the flux guiding element takes over the guidance of a magnetic field for energy transmission during an energy transmission process and the guidance of a magnetic field for positioning during a positioning process. Thus, the flux guiding element performs a dual function, which is particularly advantageous, as material and installation space can be used efficiently.

It is particularly preferable for the long-proximity positioning signal winding to be arranged around the entire width of the inductive charging device in order to cover as large an area as possible and thus generate a magnetic field that is as homogeneous as possible.

In one variant, the long-proximity positioning signal winding is arranged around at least one of the at least one flux guiding element and around the energy transmission winding. This is advantageous because the long-proximity positioning signal winding can be arranged around an otherwise pre-assembled inductive charging device. In addition, a larger area is covered by the long-proximity positioning signal winding if it is arranged around at least one of the at least one flux guiding element and around the energy transmission winding than, for example, if it is arranged around only one or more flux guiding elements. In this way, the local maximum values of the flux density are further reduced for the same power, or in other words, a higher power can be used while maintaining the flux density reference values or flux density limit values and thus a greater range can be achieved.

The long-proximity positioning signal can be an alternating magnetic field. It is advantageous if the same basic physical principle is used for a long-proximity positioning method as for energy transmission, as certain components such as flux guiding elements or electronic components can be used together. It can be particularly advantageous if both the short-proximity positioning signals and the long-proximity positioning signals are alternating magnetic fields. Here again, further components can be used together. For example, both signal types—long-proximity positioning signal and short-proximity positioning signal—can be received with the same sensor.

An alternating magnetic field can be generated, for example, by means of a coil or a current-carrying winding of a coil. The alternating magnetic field can have a frequency between 100 and 150 kHz. Preferably, the frequency can be between 110 and 148.5 kHz. For example, the frequency used may be one of the following frequencies: 145.560 kHz and 145.985 kHz and 146.843 kHz and 147.275 kHz.

The invention also relates to a vehicle charging system with a mobile inductive charging device and a stationary inductive charging device, wherein the mobile inductive charging device is designed in accordance with the invention and the stationary inductive charging device has a positioning receiver unit or the stationary inductive charging device is designed in accordance with the invention and the mobile inductive charging device has a positioning receiver unit.

It is advantageous if the transmission and reception of the positioning signals, both the long-proximity positioning signals and the short-proximity positioning signals, takes place in the respective inductive charging device, as this is where the most accurate information about a precise position or position deviation can be obtained. One of the two inductive charging devices can be designed according to the invention and have a long-proximity and a short-proximity positioning transmitter unit. The other inductive charging device can have a positioning receiver unit. A positioning receiver unit is suitable for receiving a short-proximity and/or a long-proximity positioning signal.

The inductive charging device with the positioning receiver unit has the advantage of having at least one flux guiding element and at least one sensor device with at least one first sensor winding and at least one second sensor winding.

The sensor unit is used to receive the short-proximity and/or long-proximity positioning signals and is thus the central element of the positioning receiver unit.

A sensor winding according to the invention can be designed in different forms and can have half, one or preferably several turns. Of course, an incomplete number of turns, such as 2.5 turns, is also possible. A conductor of such a sensor winding can have a cross-sectional area of between 0.01 and 2 mm², for example. A conductor can be designed here as a stranded wire, as a single conductor or in another form, for example in the form of a circuit board. In a conductor structure realized on a circuit board, the conductor paths can have cross-sections of the order of 0.8 mm to 35 μm, for example.

Preferably, the at least one flux guiding element is suitable for guiding a magnetic field during an energy transmission process, which takes place between the mobile inductive charging device and the stationary inductive charging device, and the first sensor winding and the second sensor winding are arranged around at least one of the at least one flux guiding element.

Due to the arrangement of the first sensor winding and the second sensor winding around at least one of the at least one flux guiding element, the at least one of the at least one flux guiding element assumes a dual function here. It acts both as a magnetic core for the first sensor winding and/or the second sensor winding and as a magnetic core or flux guiding element for the energy transmission winding. This means that no separate flux guiding element is required for the sensor winding, which simplifies production.

The arrangement of a sensor winding around a flux guiding element here means that at least part of the flux guiding element is enclosed by a sensor winding. The first sensor winding and the second sensor winding can be arranged around the same flux guiding element or around two different flux guiding elements, or each can be arranged around several flux guiding elements.

The two sensor windings can either be arranged only around one or more flux guiding elements or also around other elements, such as the energy transmission winding and/or around a cooling device and/or around a shielding device.

In a favorable embodiment, the first sensor winding has a first radial longitudinal direction and the second sensor winding has a second radial longitudinal direction and the first radial longitudinal direction and the second radial longitudinal direction are arranged at least approximately perpendicular to one another.

In general, a winding extends in at least two dimensions around an axis. The main direction of extension perpendicular to the winding axis is referred to here as the radial longitudinal direction. The main direction of extension therefore runs along or parallel to the longer side of the rectangle in the case of a winding with a rectangular, non-square cross-section. In the case of a winding with an elliptical cross-section, the radial longitudinal direction runs along or parallel to the main axis of the ellipse. The radial longitudinal direction of a sensor winding according to the invention can preferably lie in a plane that extends parallel to the substrate.

A corresponding arrangement of the angles of the radial longitudinal directions is advantageous for the highest possible sensitivity during detection and the simplest possible calculation of the positional deviation between the vehicle and the stationary inductive charging device.

The first sensor winding and the second sensor winding can have an extension of between 10 mm and 60 mm along the winding axis. Preferably, the first sensor winding and the second sensor winding have an extension of 40 mm along the winding axis.

The first sensor winding and the second sensor winding can preferably each have between 10 and 20 turns. It is particularly preferred that the first sensor winding and the second sensor winding each have 15 turns.

The first sensor winding has a first radial longitudinal direction and the second sensor winding has a second radial longitudinal direction, and the first radial longitudinal direction and the second radial longitudinal direction are arranged at least approximately axially symmetrical to the longitudinal direction of the vehicle or to the nominal longitudinal direction of the vehicle.

If the two angles between the respective radial longitudinal direction of the sensor windings and the longitudinal direction of the vehicle or nominal longitudinal direction of the vehicle are almost the same, this means that the sensor windings are arranged symmetrically to the direction of travel.

This is particularly advantageous as the function of the sensor windings is also to detect a right-left position deviation between the inductive charging device in the vehicle and the stationary inductive charging device. Due to the symmetrical arrangement of the sensor windings in relation to the direction of travel, the corresponding voltages induced in the sensor windings are also symmetrical if the positional deviations to the right or left are the same, making it relatively easy to calculate the positional deviations from the induced voltages.

If the two angles are 45°, the two sensor windings are at a 90°angle to each other, which is ideal for optimum evaluation of the sensor signals.

Preferably, the first sensor winding has a first radial longitudinal direction and the second sensor winding has a second radial longitudinal direction and the first radial longitudinal direction and the second radial longitudinal direction are each arranged at an angle of 45°+/−10°, preferably at an angle of 45°, to the longitudinal direction of the vehicle and the first radial longitudinal direction and the second radial longitudinal direction intersect at an angle of 70°-110°, preferably perpendicularly.

It is preferred that the first sensor winding has a first radial longitudinal direction and the second sensor winding has a second radial longitudinal direction and the first radial longitudinal direction and the second radial longitudinal direction intersect in the area of the surface spanned by the energy transmission winding.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, each schematically:

FIG. 1 shows a highly simplified representation of a vehicle with an inductive charging device,

FIG. 2 shows a sectional view of an inductive charging device for a vehicle charging system,

FIG. 3 shows a top view of an inductive charging device according to the invention with a short-proximity positioning transmitter unit and a long-proximity positioning transmitter unit,

FIG. 4 shows a top view of an alternative inductive charging device according to the invention with a short-proximity positioning transmitter unit and a long-proximity positioning transmitter unit,

FIG. 5 shows a flat coil as a short-proximity positioning transmitter unit for a short-proximity positioning transmitter unit,

FIG. 6 shows an inductive charging device with a positioning receiver unit for a vehicle charging system according to the invention,

FIG. 7 shows an inductive charging device with a positioning receiver unit for a vehicle charging system according to the invention,

FIGS. 8A and 8B show a vehicle during a positioning process with a vehicle charging system according to the invention,

FIG. 8A shows a vehicle with a longitudinal direction of the vehicle and having a mobile inductive charging device during a positioning process over a stationary inductive charging device with a nominal longitudinal direction of the vehicle,

FIG. 8B shows an exemplary embodiment in which the long-proximity positioning signal winding and the four short-proximity transmission windings are arranged in the stationary inductive charging device and the sensor windings are arranged in the mobile inductive charging device.

### DETAILED DESCRIPTION

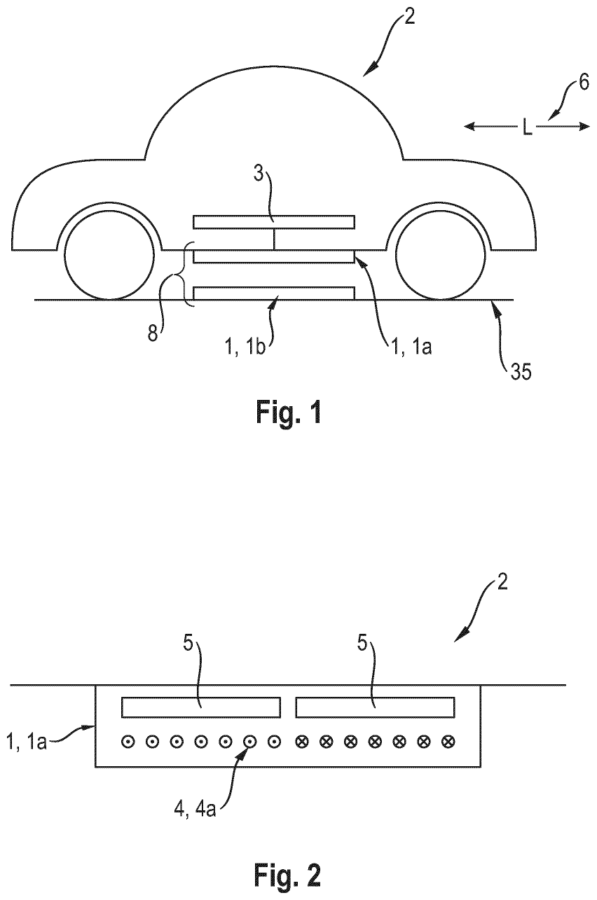

FIG. 1 shows a mobile inductive charging device Error! Reference source not found., which is arranged on a vehicle Error! Reference source not found. with an energy storage device Error! Reference source not found. and is positioned above a stationary inductive charging device Error! Reference source not found. During operation, energy can be transmitted from the stationary inductive charging device Error! Reference source not found. to the mobile inductive charging device Error! Reference source not found. and the vehicle's energy storage device Error! Reference source not found. can be charged as a result.

The mobile inductive charging device Error! Reference source not found. and the stationary inductive charging device Error! Reference source not found. together form or are part of a vehicle charging system Error! Reference source not found. In principle, it is also possible to operate the vehicle charging system Error! Reference source not found. bidirectionally. In the process, energy can be temporarily transmitted from the mobile inductive charging device Error! Reference source not found. to the stationary inductive charging device Error! Reference source not found. The stationary inductive charging device Error! Reference source not found. shown in FIG. 1 on the substrate Error! Reference source not found. can alternatively be recessed into the roadway (not shown here). In a recessed arrangement, the inductive charging device Error! Reference source not found. can be covered by certain layers of the road surface or be flush with the road surface.

FIG. 2 shows a lateral section through an inductive charging device Error! Reference source not found., Error! Reference source not found. which includes several flux guiding elements Error! Reference source not found. and an energy transmission winding Error! Reference source not found., Error! Reference source not found. and is mounted on a vehicle Error! Reference source not found.

A corresponding arrangement exists for a stationary inductive charging device Error! Reference source not found., except that it is arranged on a substrate instead of on a vehicle Error! Reference source not found. (not shown).

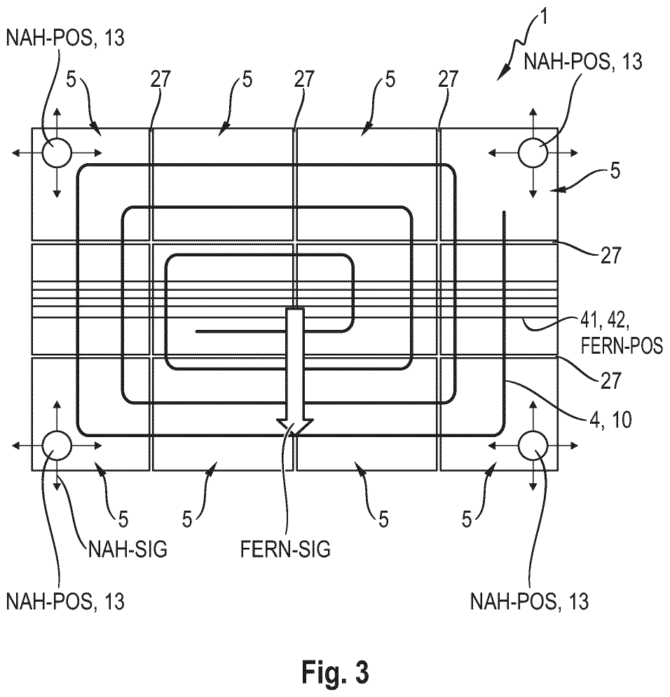

FIG. 3 shows a top view of an inductive charging device according to the invention with a short-proximity positioning transmitter unit SHORT-POS and a long-proximity positioning transmitter unit LONG-POS. The short-proximity positioning transmitter unit SHORT-POS is realized here in the form of four near transmission windings Error! Reference source not found. The long-proximity positioning transmitter unit LONG-POS is realized here as a solenoid Error! Reference source not found. The long-proximity positioning transmitter unit LONG-POS transmits a long-proximity positioning signal LONG-SIG in the form of an alternating magnetic field during a positioning process. During a positioning process, the short-proximity positioning transmitter unit SHORT-POS emits several short-proximity positioning signals SHORT-SIG in the form of alternating magnetic fields which differ, for example, in frequency.

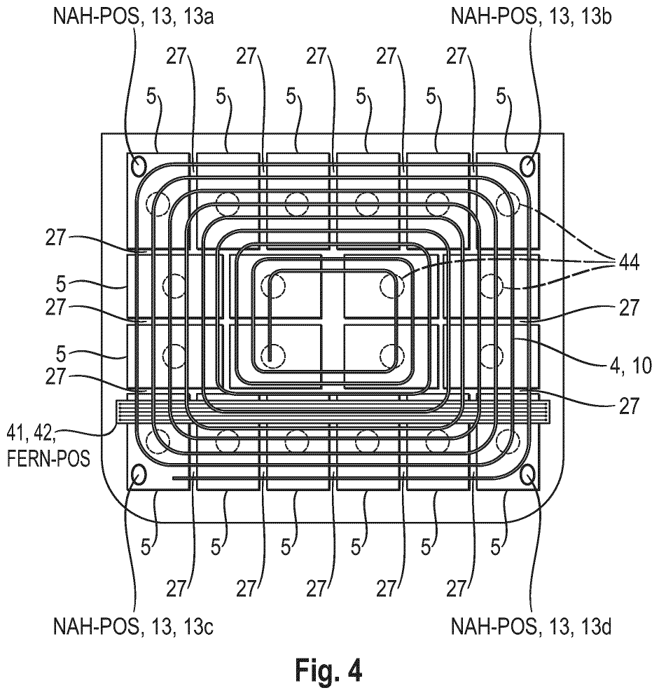

FIG. 4 shows a top view of an alternative inductive charging device according to the invention with a short-proximity positioning transmitter unit SHORT-POS and a long-proximity positioning transmitter unit LONG-POS. Here, too, the short-proximity positioning transmitter unit SHORT-POS is realized as four short-proximity transmission windings 13 and the long-proximity positioning transmitter unit LONG-POS as a solenoid Error! Reference source not found. This embodiment shows an alternative arrangement of the flux guiding elements Error! Reference source not found., furthermore the long-proximity positioning signal winding Error! Reference source not found. does not run centrally through the middle of the inductive charging device Error! Reference source not found., but is shifted towards one edge.

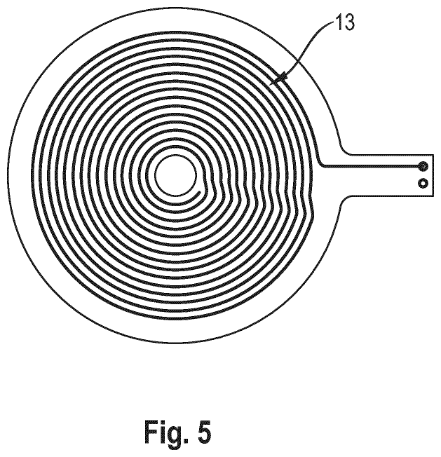

FIG. 5 shows a short-proximity transmission winding Error! Reference source not found., which is designed as a flat coil Error! Reference source not found.

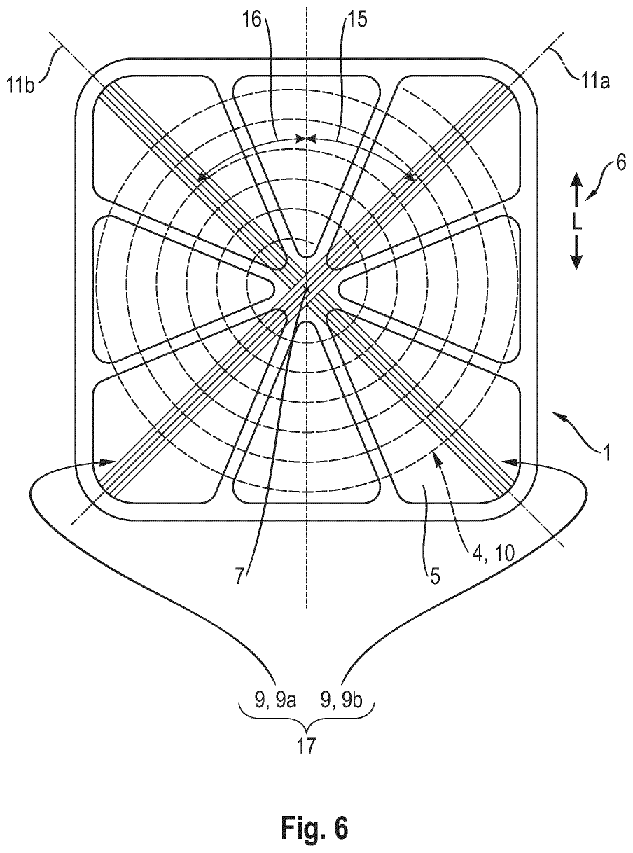

FIG. 6 shows a further inductive charging device 1 which has a positioning receiver unit Error! Reference source not found. with two sensor windings 9a and 9b, which are part of a sensor device. This can be a mobile inductive charging device Error! Reference source not found. or a stationary inductive charging device Error! Reference source not found. In the present exemplary embodiment, eight flux guiding elements Error! Reference source not found. are shown, which are arranged radially around the center Error! Reference source not found. of the energy transmission winding Error! Reference source not found. in the plane. There are narrow gaps Error! Reference source not found. between the flux guiding elements Error! Reference source not found. The gaps also run radially around the center Error! Reference source not found., so the gaps run almost in the main direction of the magnetic field lines (three magnetic field lines Error! Reference source not found. symbolically indicated here), which occurs when energy is transmitted in the flux guiding elements Error! Reference source not found. The energy transmission winding Error! Reference source not found., which is covered by the flux guiding elements Error! Reference source not found. in the top view, is indicated by a dashed line. The energy transmission winding Error! Reference source not found. is a flat coil Error! Reference source not found.

The sensor windings are designed here as a solenoid, also known as a cylindrical coil.

The first sensor winding Error! Reference source not found. runs around two flux guiding elements Error! Reference source not found. which are diagonally opposite each other with respect to the center Error! Reference source not found. of the energy transmission coil Error! Reference source not found. The second sensor winding Error! Reference source not found. is accordingly wound around two further flux guiding elements Error! Reference source not found., which are also diagonally opposite each other with respect to the center Error! Reference source not found. The first sensor winding Error! Reference source not found. is arranged axially symmetrical to the second sensor winding Error! Reference source not found. with respect to the longitudinal direction of the vehicle Error! Reference source not found. The first sensor winding Error! Reference source not found. and the second sensor winding Error! Reference source not found. cross at least almost in the center Error! Reference source not found. of the energy transmission coil Error! Reference source not found.

The first sensor winding Error! Reference source not found. has a first radial longitudinal direction Error! Reference source not found. and the second sensor winding Error! Reference source not found. has a second radial longitudinal direction Error! Reference source not found. The angle Error! Reference source not found. between the first radial longitudinal direction Error! Reference source not found. and the longitudinal direction of the vehicle Error! Reference source not found. is at least almost the same as the angle Error! Reference source not found. between the second radial longitudinal direction Error! Reference source not found. and the longitudinal direction of the vehicle Error! Reference source not found.

During the charging process, the vehicle Error! Reference source not found. is positioned above the stationary inductive charging device Error! Reference source not found. and energy is transmitted to the inductive charging device Error! Reference source not found. The flux guiding elements Error! Reference source not found. assume the function of the flux guiding. When they are charged, the field lines of the magnetic field run approximately in a radial direction in them. As the first radial longitudinal direction Error! Reference source not found. and the second radial longitudinal direction Error! Reference source not found. are also aligned radially and therefore at least almost parallel to the magnetic field lines, relatively little to no voltage is induced in the first sensor winding Error! Reference source not found. and in the second sensor winding Error! Reference source not found. in this case. This is important, as the high power of the energy transmission and therefore high flux densities could otherwise easily destroy the sensor windings. Additional effort to prevent the destruction of the arrangement is therefore not necessary.

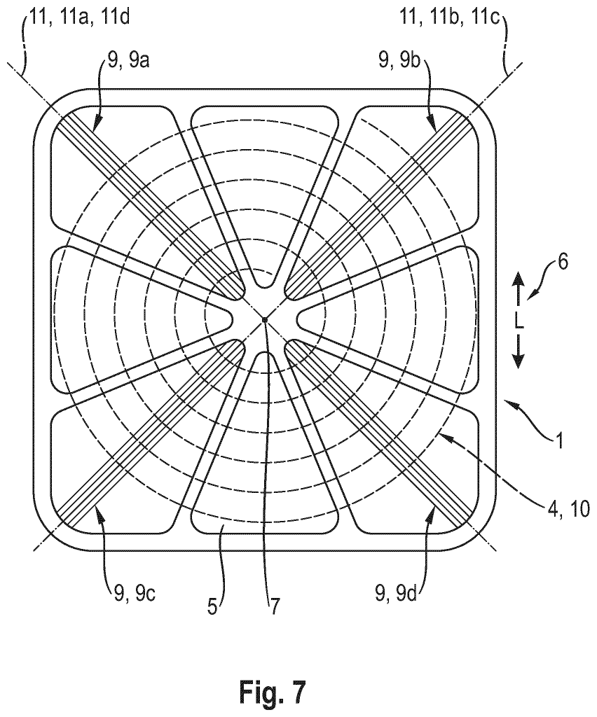

FIG. 7 shows a top view of a further exemplary embodiment of an inductive charging device Error! Reference source not found. according to the invention. Here there are four sensor windings Error! Reference source not found., Error! Reference source not found., Error! Reference source not found., Error! Reference source not found. with four radial longitudinal directions Error! Reference source not found., Error! Reference source not found., Error! Reference source not found., Error! Reference source not found. Each sensor winding is arranged around a different flux guiding element Error! Reference source not found. Two of the flux guiding elements are diagonally opposite each other in relation to the center Error! Reference source not found. of the energy transmission coil Error! Reference source not found. Together, the four sensor windings Error! Reference source not found., Error! Reference source not found., Error! Reference source not found., and Error! Reference source not found. again form a cross-shaped arrangement. An advantage over the arrangement in FIG. 6 is that the area around the center Error! Reference source not found. of the energy transmission coil Error! Reference source not found. is designed without a sensor winding Error! Reference source not found. in this case. This means that mechanically necessary support elements (not shown) can still be arranged here.

The inductive charging device according to the invention from FIG. 3 and FIG. 4 and the further inductive charging device from FIG. 6 and FIG. 7 can be part of a vehicle charging system according to the invention Error! Reference source not found. according to the invention. Here, the one positioning receiver unit Error! Reference source not found. can receive signals from the short-proximity positioning transmitter unit SHORT-POS as well as signals from the long-proximity positioning transmitter unit LONG-POS. This is advantageous because one positioning receiver unit Error! Reference source not found. can be used to operate two different positioning methods that function optimally at two different distance ranges.

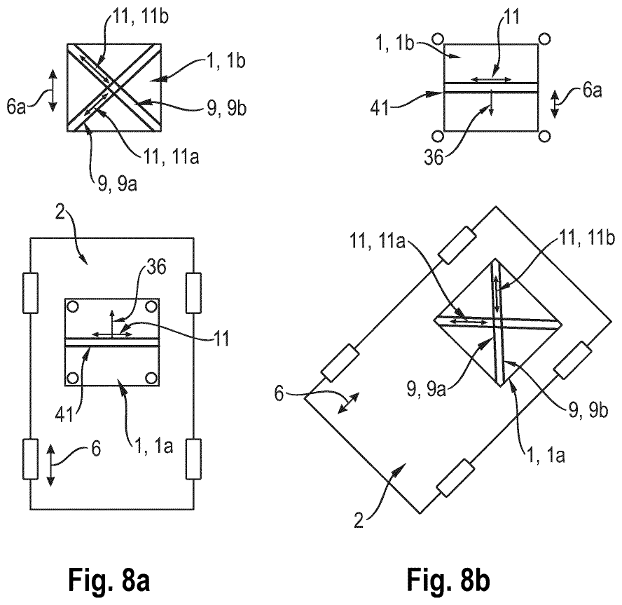

FIG. 8A shows a vehicle Error! Reference source not found. with a longitudinal direction of the vehicle Error! Reference source not found. and having a mobile inductive charging device Error! Reference source not found. during a positioning process over a stationary inductive charging device Error! Reference source not found. with a nominal longitudinal direction of the vehicle Error! Reference source not found. The vehicle Error! Reference source not found. drives directly towards the stationary inductive charging device Error! Reference source not found. and the nominal longitudinal direction of the vehicle Error! Reference source not found. is therefore the same as the longitudinal direction of the vehicle Error! Reference source not found. In the mobile inductive charging device Error! Reference source not found., in addition to the energy transmission winding (not shown), there is also a long-proximity positioning signal winding Error! Reference source not found. and four short-proximity transmission windings Error! Reference source not found. The long-proximity positioning signal winding Error! Reference source not found. has a winding axis Error! Reference source not found. and a radial longitudinal direction Error! Reference source not found. The four short-proximity transmission windings Error! Reference source not found. have winding axes perpendicular to the substrate. The stationary inductive charging device Error! Reference source not found. has two sensor windings Error! Reference source not found. and Error! Reference source not found. in addition to the energy transmission winding (not shown). Both sensor windings Error! Reference source not found. and Error! Reference source not found. each have a radial longitudinal direction Error! Reference source not found. and Error! Reference source not found. Both sensor windings Error! Reference source not found. and Error! Reference source not found. are arranged symmetrically to the nominal longitudinal direction of the vehicle Error! Reference source not found. This arrangement of the windings for positioning is particularly advantageous. The long-proximity positioning signal winding Error! Reference source not found. generates a fairly homogeneous magnetic field. A voltage is induced in the sensor windings Error! Reference source not found. and Error! Reference source not found. by the magnetic field of the long-proximity positioning signal winding Error! Reference source not found. If the vehicle drives exactly perpendicular to the stationary inductive charging device Error! Reference source not found. as shown in the left-hand sketch, an equal voltage is induced in both sensor windings Error! Reference source not found. and Error! Reference source not found. during the long-proximity positioning method. From a certain distance, the short-proximity positioning method is used and the short-proximity positioning signals SHORT-SIG emitted by the short-proximity transmission windings Error! Reference source not found. are evaluated.

FIG. 8B shows an exemplary embodiment in which the long-proximity positioning signal winding Error! Reference source not found. and the four short-proximity transmission windings Error! Reference source not found. are arranged in the stationary inductive charging device Error! Reference source not found. and the sensor windings Error! Reference source not found. and Error! Reference source not found. are arranged in the mobile inductive charging device Error! Reference source not found. Otherwise, this exemplary embodiment works in exactly the same way. The figure shows a case in which the vehicle Error! Reference source not found. does not approach the stationary inductive charging device Error! Reference source not found. perpendicularly, but deviates from it at an angle of approx. 45°. The longitudinal direction of the vehicle Error! Reference source not found. and the connecting line between the stationary inductive charging device Error! Reference source not found. and the mobile inductive charging device Error! Reference source not found. are therefore at a directional deviation angle of 45°from each other. In this case, the long-proximity positioning signal winding Error! Reference source not found. generates a magnetic field which is perpendicular to the first sensor winding Error! Reference source not found. Here, a maximum voltage is induced into the first sensor winding Error! Reference source not found. during the long-proximity positioning method. The magnetic field generated by the long-proximity positioning signal winding Error! Reference source not found. is also almost parallel to the second sensor winding Error! Reference source not found. A minimum or no voltage is induced here during the long-proximity positioning method. Here too, the short-proximity positioning method can take over from a certain distance.

1. An inductive charging device for a vehicle charging system, comprising:
an energy transmission winding;
at least one flux guiding element;
a short-proximity positioning transmitter unit configured to provide at least one short-proximity positioning signal;
and
a long-proximity positioning transmitter unit configured to provide at least one long-proximity positioning signal.

2. The inductive charging device according to claim 1, wherein:
the inductive charging device is a mobile inductive charging device arranged on and/or in a vehicle; or
the inductive charging device is a stationary inductive charging device.

3. The inductive charging device according to claim 1, wherein the short-proximity positioning transmitter unit includes a plurality of short-proximity transmitter windings arranged at a distance from one another.

4. The inductive charging device according to claim 3, wherein the plurality of short-proximity transmission windings have a winding axis extending perpendicular to a substrate.

5. The inductive charging device according to claim 3, wherein the plurality of short-proximity transmitting windings are each configured to provide a short-proximity positioning signal of a plurality of short-proximity positioning signals.

6. The inductive charging device according to claim 5, wherein the plurality of short-proximity positioning signals are alternating magnetic fields with:
different frequencies; or
the same frequency but different pulse widths.

7. The inductive charging device according to claim 1, wherein:
the long-proximity positioning transmitter unit includes a long-proximity positioning signal winding;
the long-proximity positioning signal winding is a solenoid with a winding axis extending in a longitudinal direction of a vehicle or a nominal longitudinal direction of the vehicle;
the at least one flux guiding element is configured to guide a magnetic field during an energy transmission process between a further inductive charging device and the energy transmission winding;
the long-proximity positioning signal winding encloses the at least one flux guiding element; and
the long-proximity positioning signal winding is configured to provide the at least one long-proximity positioning signal.

8. The inductive charging device according to claim 6, wherein the at least one long-proximity positioning signal is an alternating magnetic field.

9. A vehicle charging system, comprising an inductive charging device according to claim 1 and a further inductive charging device, the further inductive charging device including a positioning receiver unit, wherein:
the inductive charging device is a mobile inductive charging device inductive and the further inductive charging device is a stationary inductive charging device; or
the inductive charging device is a stationary inductive charging device and the further inductive charging device is a mobile inductive charging device.

10. The vehicle charging system according to claim 9, wherein the further inductive charging device includes at least one flux guiding element and at least one sensor device with at least one first sensor winding and at least one second sensor winding.

11. The vehicle charging system according to claim 10, wherein:
the at least one flux guiding element of the further inductive charging device is configured to guide a magnetic field during an energy transmission process between the mobile inductive charging device and the stationary inductive charging device; and
the at least one first sensor winding and the at least one second sensor winding are arranged around the at least one flux guiding element of the further inductive charging device.

12. The vehicle charging system according to claim 10, wherein:
the at least one first sensor winding has a first radial longitudinal direction and the at least one second sensor winding has a second radial longitudinal direction; and
the first radial longitudinal direction and the second radial longitudinal direction are arranged at least approximately perpendicular to each other.

13. The vehicle charging system according to claim 10, wherein:
the at least one first sensor winding has a first radial longitudinal direction and the at least one second sensor winding has a second radial longitudinal direction and
the first radial longitudinal direction and the second radial longitudinal direction are arranged approximately axially symmetrically to a longitudinal direction of a vehicle or a nominal longitudinal direction of the vehicle.

14. The vehicle charging system according to claim 9, wherein the short-proximity positioning transmitter unit includes a plurality of short-proximity transmitter windings disposed spaced apart from one another

15. The vehicle charging system according to claim 14, wherein the plurality of short-proximity transmission windings have a winding axis extending perpendicular to a substrate.

16. The vehicle charging system according to claim 9, wherein:
the at least one short-proximity positioning signal includes a plurality of short-proximity positioning signals; and
the plurality of short-proximity positioning signals are alternating magnetic fields with:
different frequencies; and/or
different pulse widths.

17. The vehicle charging system according to claim 9, wherein:
the long-proximity positioning transmitter unit includes a long-proximity positioning signal winding configured to provide the at least one long-proximity positioning signal;
the long-proximity positioning signal winding is a solenoid with a winding axis extending in a longitudinal direction of a vehicle or a nominal longitudinal direction of the vehicle;
the long-proximity positioning signal winding encloses the at least one flux guiding element; and
the at least one flux guiding element is configured to guide a magnetic field during an energy transmission process between the further inductive charging device and the energy transmission winding.

18. The inductive charging device according to claim 1, wherein the inductive charging device is a mobile inductive charging device arranged on and/or in a vehicle.

19. The inductive charging device according to claim 1, wherein the inductive charging device is a stationary inductive charging device.

20. The inductive charging device according to claim 3, wherein the plurality of short-proximity transmitter windings includes at least four short-proximity transmitter windings.
